(19) United States
(12) Patent Application Publication
(10) Pub. No.: US 2016/0292175 A1
(43) Pub. Date: Oct. 6, 2016

(54) SYSTEMS AND METHODS FOR SYSTEM-AWARE IDENTITY MANAGEMENT OF CENTRAL DATA STORAGE HUBS

(71) Applicant: Profisee Group, Inc., Alpharetta, GA (US)

(72) Inventors: Tyler Darren GRAHAM, Roswell, GA (US); Brian BARNETT, Alpharetta, GA (US)

(21) Appl. No.: 15/087,262

(22) Filed: Mar. 31, 2016

Related U.S. Application Data
(60) Provisional application No. 62/140,914, filed on Mar. 31, 2015.

(51) Int. Cl. G06F 17/30

(52) U.S. Cl. CPC G06F 17/30106; G06F 17/30483; G06F 17/30595

(57) ABSTRACT

Systems and methods for system-aware identity management that enables a central data storage hub to interact with one or more external systems without complex ETL tools or multiple calls to determine the data structure of the hub. In various embodiments, the central data storage hub uses unique system identifiers and metadata tags to determine the appropriate data attributes corresponding to a particular external system.

### CROSS REFERENCE TO RELATED APPLICATIONS

This application claims priority to, the benefit under 35 U.S.C. §119 of, and incorporates by reference herein in its entirety U.S. Provisional Patent Application No. 62/140,914, filed Mar. 31, 2015, and entitled “Systems and Methods for Central Data Storage Hub System Aware Identity Management.”

### TECHNICAL FIELD

The present systems and methods relate generally to master data management and, more particularly, system-aware identity management of relational databases.

### BACKGROUND

Central data storage hubs permit the storage of increasingly complex amounts of data in a centralized system (e.g., in an enterprise setting comprising multiple systems such as a system for sales, inventory management, etc.). These centralized systems, however, generally require knowledge of the data structure of the databases to permit interaction with the same. For example, if an external caller, from an external system, attempted to call into a centralized system (e.g., as part of an update or retrieve request) but was unaware of the data structure of the centralized system, then the external caller would need to make multiple calls to the centralized system to receive enough information regarding that data structure to properly format the call. These calls can be time consuming and require burdensome extract, transform, and load tools (e.g. “ETL” tools) to perform the same. Additionally, the need for these multiple calls may create unintended consequences (e.g., errors) when data is deleted from the centralized system.

Therefore, there is a long-felt but unresolved need for a system or method that permits external systems to interact with central data storage hubs without the use of complex ETL tools or knowledge of the hub's underlying data structure.

### BRIEF SUMMARY OF THE DISCLOSURE

Briefly described, and according to one embodiment, aspects of the present disclosure generally relate to systems and methods that permit external systems to interact with central data storage hubs without the use of complex ETL tools or knowledge of the underlying data structure of the hub.

Generally, the present disclosure relates to system-aware identity management (e.g., “SAIM”) that enables a central data storage hub (comprising one or more databases) to interact with one or more external systems without complex ETL tools or multiple calls to determine the data structure of the hub. At its most basic level, the data structure of the hub generally comprises data entries with data regarding various attributes. In various embodiments, data entries correspond to a particular item about which the hub is tracking/storing information (e.g., a particular product in a company's inventory, etc.), and attributes are the particular details/characteristics of that particular data item (e.g., size, inventory status, name, SKU#, etc.). Accordingly, the hub may be operatively connected to one or more external systems (e.g., software, hardware, or combinations of both) deployed by an enterprise or organization that use the data that is centrally stored within the hub (e.g., sales systems, inventory management systems, etc.) through one or more application program interfaces (e.g., APIs) or other data transfer method.

In various embodiments, the hub generates a unique system identifier for each external system that exclusively identifies that external system to the hub. As part of a configuration process, the hub tags each data attribute that is unique to the external system, including those data attributes that may be record identifiers (e.g., identifying particular data entries), with a system identifier that corresponds to the unique system identifier/external system so that the hub is aware, when receiving a call from the external system, of which attributes the external system uses. Thus, instead of the external system implementing complex ETL tools to interact with, make multiple calls to determine the data structure of, or have a pre-existing understanding of the data structure of the hub, the hub will instead translate a call from the external system to determine the attributes and data records for which the external system has requested data (as part of a retrieve call) or provided data (as part of an update call).

To make a call, in various embodiments, the external system will provide its unique system identifier, one or more record identifiers, and a list of attributes for which it wants to retrieve/update data. The hub generally will determine the unique system identifier from the call and use that unique system identifier to determine the managed attributes and record identifier location within the hub that correspond to the attributes (or record identifier) of the external system. Once the hub has determined the appropriate managed attributes and record identifiers, then it will conduct the operation (e.g., retrieve, update, etc.) requested by the call. In various embodiments, the hub may conduct the operation according to various policies that define a hierarchy of interaction between the external systems and the hub (e.g., indicating which external systems may update certain attributes or which external system's data takes priority in the case of inconsistencies). Additionally, in one embodiment, the hub may format any data that it provides to the external system so that the data is compatible with the external system.

In one embodiment, a method, comprising the steps of: receiving, at a centralized data repository, a retrieve call from an external system, wherein the retrieve call comprises a unique system identifier identifying the external system and one or more external system attributes about which to retrieve at least one electronic data record from the centralized data repository; parsing the retrieve call to extract the unique system identifier; determining, based on the unique system identifier, one or more centralized data repository attributes corresponding to the one or more external system attributes; retrieving, from the centralized data repository, one or more electronic data records corresponding to the one or more centralized data repository attributes; and transmitting, from the centralized data repository, the retrieved one or more electronic data records to the external system.

In one embodiment, a system, comprising: an external system that generates a retrieve call and transmits the retrieve call to a centralized data repository, wherein the retrieve call comprises a unique system identifier identifying the external system and one or more external system attributes about which to retrieve at least one electronic data record from the centralized data repository; the centralized data repository that receives the retrieve call from the external system, wherein the centralized data repository: parses the retrieve call to extract the unique system identifier, determines, based on the unique system identifier, one or more centralized data repository attributes corresponding to the one or more external system attributes; retrieves one or more electronic data records corresponding to the one or more centralized data repository attributes; and transmits the retrieved one or more electronic data records back to the external system; and the external system that receives the retrieved one or more electronic data records from the centralized data repository, wherein the external system updates itself based on the retrieved one or more electronic data records.

In one embodiment, a method, comprising the steps of: receiving, at a centralized data repository, an update call from an external system, wherein the update call comprises a unique system identifier, one or more external system attributes about which to update at least one electronic data record, and electronic data to be updated within the at least one electronic data record; parsing the update call to extract the unique system identifier; determining, based on the unique system identifier, one or more centralized data repository attributes corresponding to the one or more external system attributes; identifying one or more electronic data records corresponding to the one or more centralized data repository attributes; and replacing the identified one or more electronic data records with the electronic data at positions in the one or more electronic data records corresponding to the one or more centralized data repository attributes.

In one embodiment, a system, comprising: an external system that generates an update call and transmits the update call to a centralized data repository, wherein the update call comprises a unique system identifier, one or more external system attributes about which to update at least one electronic data record, and electronic data to be updated within the at least one electronic data record; and the centralized data repository that receives the update call from the external system, wherein the centralized data repository: parses the update call to extract the unique system identifier; determines, based on the unique system identifier, one or more centralized data repository attributes corresponding to the one or more external system attributes; identifies one or more electronic data records corresponding to the one or more centralized data repository attributes; and replaces the identified one or more electronic data records with the electronic data at positions in the one or more electronic data records corresponding to the one or more centralized data repository attributes.

According to one aspect of the present disclosure, the method, wherein the one or more external system attributes comprise one or more external system electronic data record identifiers, wherein the one or more external system electronic data record identifiers specify the at least one electronic data record. Furthermore, the method, wherein determining, based on the unique system identifier, one or more centralized data repository attributes corresponding to the one or more external system attributes further comprises determining one or more centralized data repository electronic data record identifiers corresponding to the one or more external system electronic data record identifiers, wherein the one or more centralized data repository electronic data record identifiers specify the one or more electronic data records. Moreover, the method, wherein retrieving, from the centralized data repository, one or more electronic data records corresponding to the one or more centralized data repository attributes further comprises retrieving, from the centralized data repository, one or more electronic data records corresponding to the one or more centralized data repository attributes and the one or more one or more centralized data repository electronic data record identifiers. Further, the method, further comprising the step of, prior to transmitting the retrieved one or more electronic data records, formatting the retrieved one or more electronic data records to ensure compatibility with the external system. Additionally, the method, wherein the centralized data repository comprises one or more relational databases. Also, the method, wherein the external system comprises one or more relational databases. In addition, the method, wherein the retrieve call is received at the centralized data repository through one or more application program interfaces.

According to one aspect of the present disclosure, the system, wherein the one or more external system attributes comprise one or more external system electronic data record identifiers, wherein the one or more external system electronic data record identifiers specify the at least one electronic data record. Furthermore, the system, wherein the centralized data repository, to determine, based on the unique system identifier, one or more centralized data repository attributes corresponding to the one or more external system attributes, further determines one or more centralized data repository electronic data record identifiers corresponding to the one or more external system electronic data record identifiers, wherein the one or more centralized data repository electronic data record identifiers specify the one or more electronic data records. Moreover, the system, wherein the centralized data repository, to retrieve one or more electronic data records corresponding to the one or more centralized data repository attributes, further retrieves, from the centralized data repository, one or more electronic data records corresponding to the one or more centralized data repository attributes and the one or more one or more centralized data repository electronic data record identifiers. Further, the system, wherein the central data repository, prior to transmitting the retrieved one or more electronic data records, formats the retrieved one or more electronic data records to ensure compatibility with the external system. Additionally, the system, wherein the centralized data repository comprises one or more relational databases. Also, the system, wherein the external system comprises one or more relational databases. In addition, the system, wherein the external system transmits and the centralized data repository receives the retrieve call through one or more application program interfaces.

According to one aspect of the present disclosure, the method, wherein the step of replacing the identified one or more electronic data records further comprises the steps of: retrieving one or more update policies; comparing the electronic data to the one or more update policies; and replacing, based on the comparison, the identified one or more electronic data records with the electronic data. Furthermore, the method, wherein the one or more external system attributes comprise one or more external system electronic data record identifiers, wherein the one or more external system electronic data record identifiers specify the at least one electronic data record. Moreover, the method, wherein determining, based on the unique system identifier, one or more centralized data repository attributes corresponding to the one or more external system attributes further comprises determining one or more centralized data repository electronic data record identifiers corresponding to the one or more external system electronic data record identifiers, wherein the one or more centralized data repository electronic data record identifiers specify the one or more electronic data records. Further, the method, wherein identifying one or more electronic data records corresponding to the one or more centralized data repository attributes further comprises identifying one or more electronic data records corresponding to the one or more centralized data repository attributes and the one or more one or more centralized data repository electronic data record identifiers. Additionally, the method, further comprising the step of, prior to replacing the identified one or more electronic data records, formatting the electronic data to ensure compatibility with the centralized data repository. Also, the method, wherein the centralized data repository comprises one or more relational databases. In addition, the method, wherein the external system comprises one or more relational databases. Furthermore, the method, wherein the update call is received at the centralized data repository through one or more application program interfaces.

According to one aspect of the present disclosure, the system, wherein the centralized data repository, to replace the identified one or more electronic data records: retrieves one or more update policies; compares the electronic data with the one or more update policies; and replaces, based on the comparison, the identified one or more electronic data records with the electronic data. Moreover, the system, wherein the one or more external system attributes comprise one or more external system electronic data record identifiers, wherein the one or more external system electronic data record identifiers specify the at least one electronic data record. Further, the system, wherein the centralized data repository, to determine, based on the unique system identifier, one or more centralized data repository attributes corresponding to the one or more external system attributes, further determines one or more centralized data repository electronic data record identifiers corresponding to the one or more external system electronic data record identifiers, wherein the one or more centralized data repository electronic data record identifiers specify the one or more electronic data records. Additionally, the system, wherein the centralized data repository, to identify one or more electronic data records corresponding to the one or more centralized data repository attributes, further identifies one or more electronic data records corresponding to the one or more centralized data repository attributes and the one or more one or more centralized data repository electronic data record identifiers. Also, the system, wherein the centralized data repository, prior to replacing the identified one or more electronic data records, formats the electronic data to ensure compatibility with the centralized data repository. In addition, the system, wherein the centralized data repository comprises one or more relational databases. Furthermore, the system, wherein the external system comprises one or more relational databases. Moreover, the system, wherein the external system transmits and the centralized data repository receives the updates call through one or more application program interfaces.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system overview according to one embodiment of the present disclosure.

FIG. 2 illustrates an exemplary configuration process according to one embodiment of the present disclosure.

FIG. 3 illustrates an exemplary call process according to one embodiment of the present disclosure.

FIG. 4 illustrates exemplary SAIM central data storage hub data tables according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Aspects of the present disclosure generally relate to systems and methods that permit external systems to interact with central data storage hubs without the use of complex ETL tools or knowledge of the underlying data structure of the hub.

Generally, the present disclosure relates to system-aware identity management (e.g., “SAIM”) that enables a central data storage hub (comprising one or more databases) to interact with one or more external systems without complex ETL tools or multiple calls to determine the data structure of the hub. At its most basic level, the data structure of the hub generally comprises data entries with data regarding various attributes. In various embodiments, data entries correspond to a particular item about which the hub is tracking/storing information (e.g., a particular product in a company's inventory, etc.), and attributes are the particular details/characteristics of that particular data item (e.g., size, inventory status, name, SKU#, etc.). Accordingly, the hub may be operatively connected to one or more external systems (e.g., software, hardware, or combinations of both) deployed by an enterprise or organization that use the data that is centrally stored within the hub (e.g., sales systems, inventory management systems, etc.) through one or more application program interfaces (e.g., APIs) or other data transfer method.

In various embodiments, the hub generates a unique system identifier for each external system that exclusively identifies that external system to the hub. As part of a configuration process, the hub tags each data attribute that is unique to the external system, including those data attributes that may be record identifiers (e.g., identifying particular data entries), with a system identifier that corresponds to the unique system identifier/external system so that the hub is aware, when receiving a call from the external system, of which attributes the external system uses. Thus, instead of the external system implementing complex ETL tools to interact with, make multiple calls to determine the data structure of, or have a pre-existing understanding of the data structure of the hub, the hub will instead translate a call from the external system to determine the attributes and data records for which the external system has requested data (as part of a retrieve call) or provided data (as part of an update call).

To make a call, in various embodiments, the external system will provide its unique system identifier, one or more record identifiers, and a list of attributes for which it wants to retrieve/update data. The hub generally will determine the unique system identifier from the call and use that unique system identifier to determine the managed attributes and record identifier location within the hub that correspond to the attributes (or record identifier) of the external system. Once the hub has determined the appropriate managed attributes and record identifiers, then it will conduct the operation (e.g., retrieve, update, etc.) requested by the call. In various embodiments, the hub may conduct the operation according to various policies that define a hierarchy of interaction between the external systems and the hub (e.g., indicating which external systems may update certain attributes or which external system's data takes priority in the case of inconsistencies). Additionally, in one embodiment, the hub may format any data that it provides to the external system so that the data is compatible with the external system.

### Exemplary Embodiments

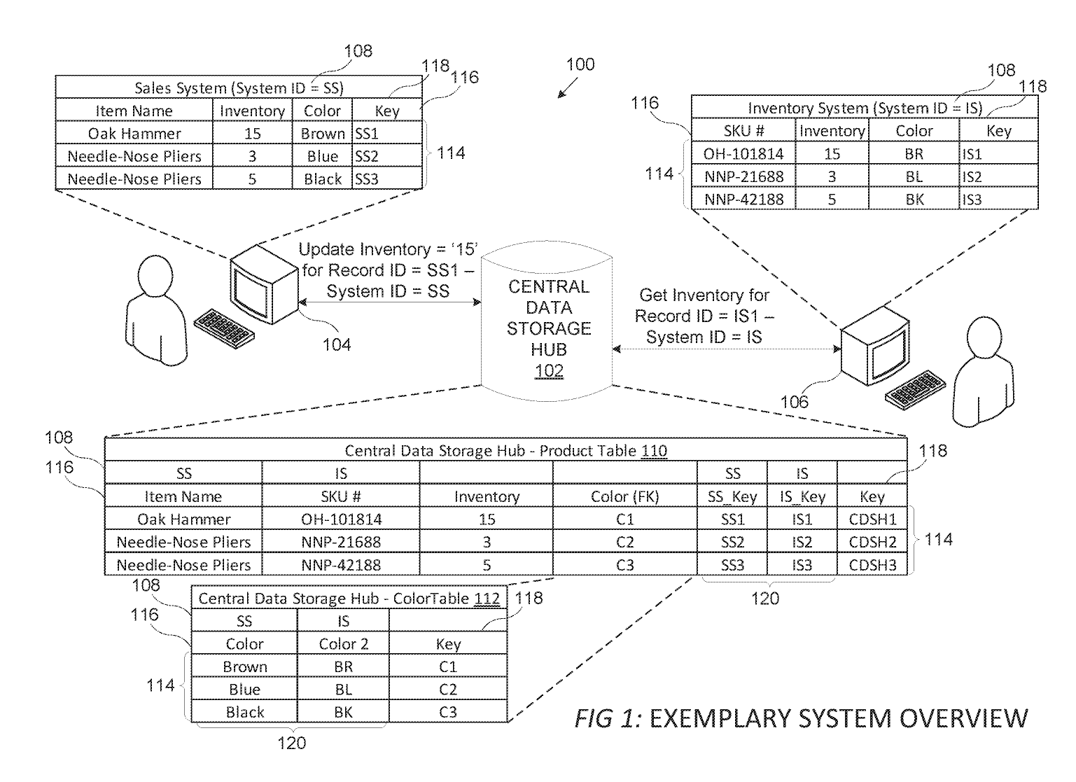

Referring now to the figures, for the purposes of example and explanation of the fundamental processes and components of the disclosed systems and methods, reference is made to FIG. 1, which illustrates an exemplary, high-level overview 100 of one embodiment of the disclosed system. As will be understood and appreciated, the exemplary, high-level overview 100 shown in FIG. 1 represents merely one approach or embodiment of the present system, and other aspects are used according to various embodiments of the present system. Generally, the disclosed system permits a centralized data repository 102 (alternatively referred to herein as a “central data storage hub” or “hub”) to interact with external systems 104, 106 (e.g., systems maintained outside of the hub 102) without the need for the external system to understand the data structure of the hub 102 or the use of complex ETL tools (e.g., “extract, transform, load”) to interact with the same through system-aware identity management (e.g., “SAIM”).

At its most basic level, the data structure of the hub 102 generally comprises data entries or records 114 (as shown in FIG. 1, rows within the data tables 110 and 112) with data regarding various attributes 116 (as shown in FIG. 1, columns within the data tables 110 and 112, alternatively referred to herein as “centralized data repository attributes”). In various embodiments, data entries correspond to a particular item (e.g., physical item, data item, etc.) that the hub 102 is tracking/storing information about, and attributes are the particular details/characteristics of that data particular item. In one embodiment, each data table 110 or 112 may comprise record identifiers 118 (a particular type of attribute 116) that are unique to that particular data table 110 or 112 and uniquely identify a particular data record 114 to that data table 110 or 112 (alternatively referred to herein as “record IDs”, “primary record identifiers”, “electronic data record identifiers”, or “centralized data repository electronic data record identifiers”). Similarly, the external systems 104 and 106 may also comprise data tables containing data records 114, with data regarding various attributes 116 (alternatively referred to herein as “external system attributes”), that are identified by record identifiers 118 (a particular type of attribute 116, alternatively referred to herein as “external system electronic data record identifiers”). Generally, the data records 114, attributes 116, and record identifiers 118 will not be the same between the external systems 104 and 106 and the data tables 110 and 112 of the hub 102 (e.g., external system attributes may be different from centralized data repository attributes although a particular external system attribute may have a corresponding centralized data repository attribute). In one embodiment, the data tables 110 and 112 may comprise primary record identifiers 118 and secondary record identifiers 120. Generally, primary record identifiers 118 (e.g., centralized data repository electronic data record identifiers) are those record identifiers that uniquely identify data records within the data table 110 or 112 in which they are located; secondary record identifiers 120, in one embodiment, correspond to primary record identifiers 118 or data in other data tables. For example, the secondary record identifiers 120 within data table 110 correspond to the primary record identifiers 118 (e.g., external system electronic data record identifiers) from the external systems 104 and 106, the secondary record identifiers 120 within data table 112 correspond to data within the external systems 104 and 106, etc.

In various embodiments, a central data storage hub 102 implementing the systems and methods of the present disclosure may interact with one or more external systems (e.g., 104 or 106) to provide enterprise-wide data management. The hub 102 and one or more external systems 104 or 106, in one embodiment, may comprise any computing device (e.g., desktop computer, laptop, servers, tablets, etc.), combination of computing devices, software, hardware, combination of software and hardware, database (e.g., stored in the cloud or on premise, structured as relational, etc.), or combination of databases that are capable of performing the functionality disclosed herein. Generally, the hub 102 and one or more external systems 104 or 106 may be operatively connected by a network that may comprise a secure or unsecured connection, local area network, the internet, etc. In various embodiments, the hub 102 may be structured as a relational database, non-relational database, one or more files, one or more in-memory objects, etc. In one embodiment, for example, the hub 102 may provide a centralized location wherein all of a company's inventory may be managed. Continuing with this example, if a sales system 104 or an inventory management system 106 wishes to retrieve or update data regarding the company's inventory, the external system 104 or 106 places a call to the hub 102 for that purpose. As will occur to one having ordinary skill in the art, the sales system 104 and the inventory management system 106 may contain/process data in different formats and contain different sets of data as compared to the hub 102 and each other. Similarly, the hub 102 may be connected with an unlimited number of external systems (e.g., 104 or 106) that make the data structure of the hub 102 exceedingly complicated. Thus, the hub 102, in various embodiments, stores all of the data used by these external systems in such a way that the data is accessible, without use of complex ETL tools or understanding of the data structure of the hub 102, by the external systems (e.g., using system identifiers 108, alternatively referred to herein as “unique system identifiers”, “system IDs”, or “metadata identifiers”). Instead, the hub 102 translates the call from the external system 104 or 106 and combines the transform and load operations of an ETL tool (e.g., generating an optimized EL tool) so that the external system 104 or 106 need only place one call to the hub 102.

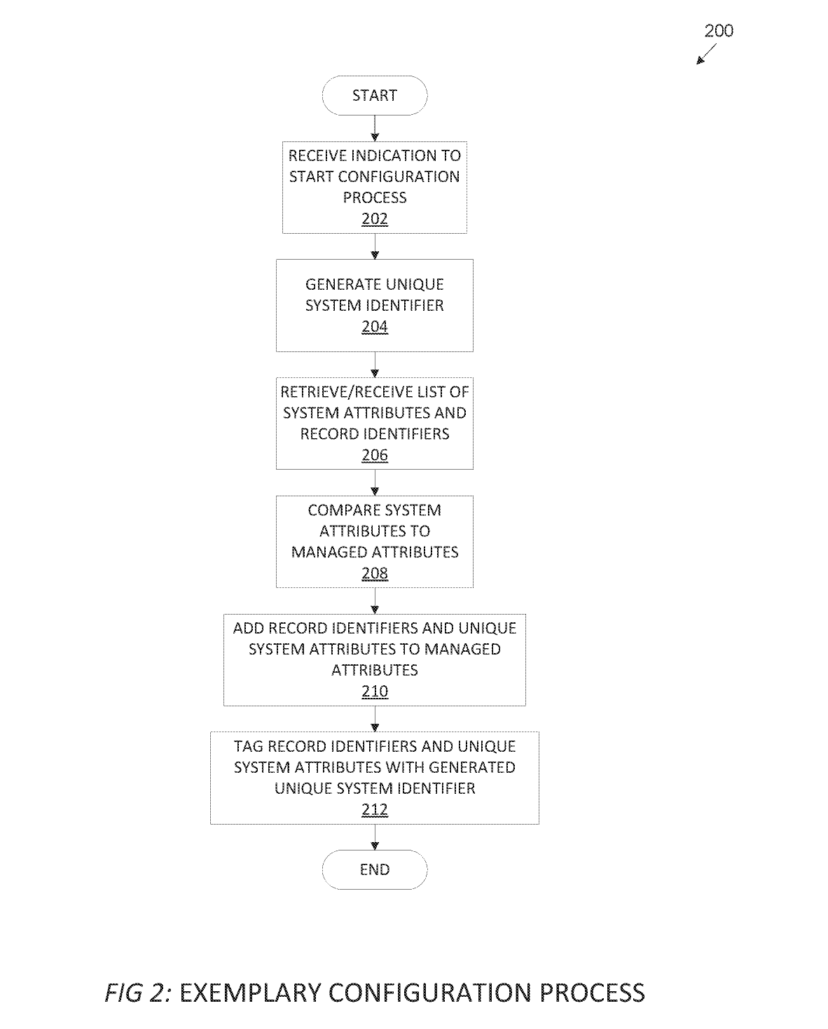

In one embodiment, the hub 102 maintains one or more relational data tables 110 and 112 (e.g., one or more data tables meeting the requirements of third normal form rules in which all of the columns that do not depend on the primary database identifier are removed). Generally, the data within the data tables 110 and 112 are tagged with system identifiers 108 that correspond to the external systems 104 and 106 so that a call from an external system (e.g., a request to retrieve/update data regarding one or more attributes or data entries) may be translated into the appropriate format (e.g., the appropriate attributes may be used to request/update the data). In one embodiment, the system identifiers 108 are embedded within a particular data table 110 or 112. In another embodiment (not shown in FIG. 1), the system identifiers 108 are included within a control data table associated with a particular data table 110 or 112. Generally, the system identifiers 108 are associated with a particular external system 104 or 106 (e.g., in the control data table) through the use of a unique system identifier (e.g., an identifier used by the hub 102 to exclusively determine the identity of a particular external system 104 or 106). Accordingly, the external system 104 or 106 identifies itself to the hub 102 by including its unique system identifier within a call to the hub 102 (as established during the configuration process, which will be described in further detail in association with the description of FIG. 2), and the hub 102 uses the unique system identifier to retrieve the system identifiers 108 relevant to the call so that the external system 104 or 106 need not understand the data structure of the hub or use complex ETL tools. Instead, the hub 102 itself translates the call from the external system 104 or 106, thus, combining the transform and load operations of an ETL tool (e.g., generating an optimized EL tool). In one non-limiting example, a company that sells hardware and other construction tools may implement a system according to the present disclosure. Continuing with this example, the company may use a sales system 104 to monitor its sales activity (e.g., leads, purchases, inventory, etc.) and an inventory management system 106 to monitor its inventory (e.g., inventory status, suppliers, etc.). As will occur to one having ordinary skill in the art, the data tables in FIG. 1 are for exemplary purposes only; this disclosure places no limitations on the type, size, format, structure, etc. of data tables. As the sales system 104 and inventory management system 106 are separate systems, they should share information between them so that the sales team and the warehouse managers have up to date information regarding the status of the company's tool inventory. For many reasons (e.g., ease of adding additional external system, ease of replacing current external systems, etc.), the company may use a central data storage hub 102 according to the present disclosure. This hub 102 may be operatively connected to both the sales system 104 and inventory management system 106 to provide the data on which the two systems operate.

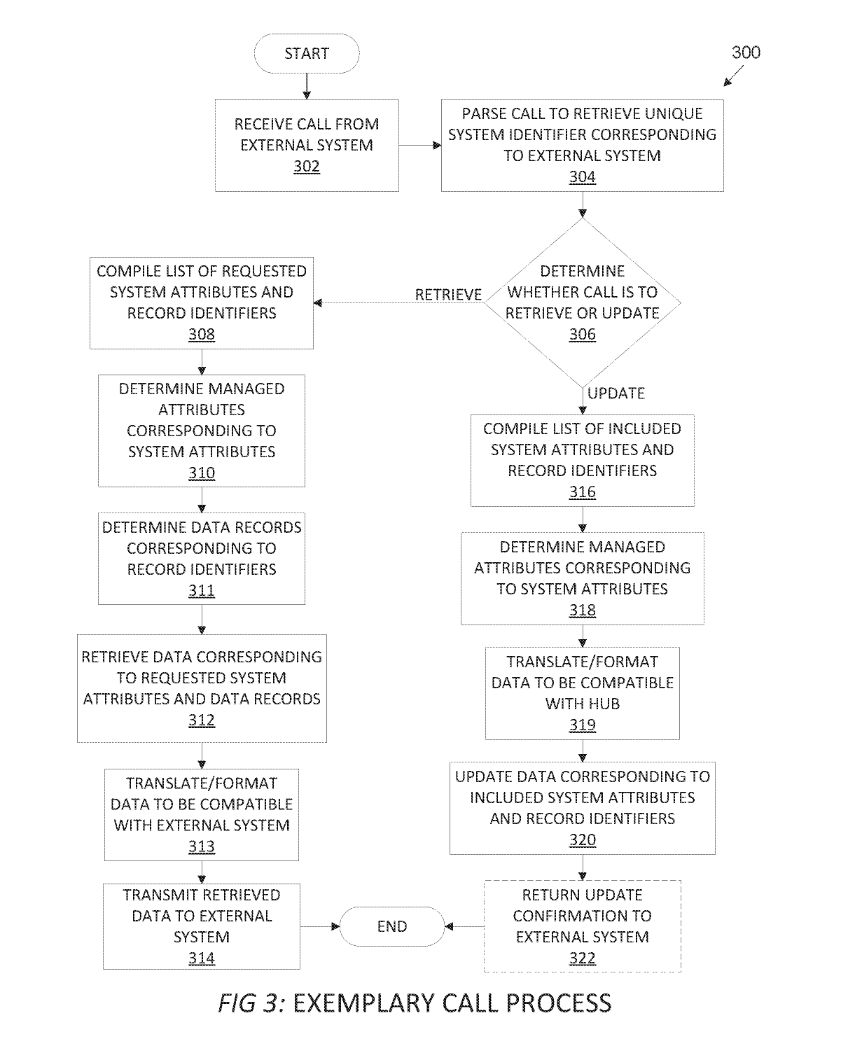

Continuing with this non-limiting example, the external systems 104 and 106 may be initially connected to the hub 102 through a configuration process (the details of which will be discussed in association with the description of FIG. 2). This configuration process generates the unique system identifier for the external system, adds new unique attributes to the hub 102 as appropriate, and tags each of the unique attributes from the external system in the hub 102, including the record identifiers 118 from those external systems (e.g., SS_Key and IS_Key in data table 110) with a system identifier 108. Once configured, the external systems 104 and 106 need only provide their unique system identifier to the hub 102 within a call for the call to be properly acted upon by the hub 102. In various embodiments, these calls may be to update data within the hub 102, retrieve data from the hub 102, etc. (the details of which will be discussed in association with the description of FIG. 3).

Still referring to this non-limiting example, if a salesman makes a sale of an oak hammer, then the salesman may update the inventory status of the oak hammers to reflect the new number of oak hammers in stock. In one embodiment, this update will be passed to the hub 102 through an update call that comprises the unique system identifier for the sales system along with the data that is to be updated (e.g., “Update Inventory=‘15’ for Record ID=SS1−System ID=SS”). When the hub 102 receives the update call, it will parse the call to retrieve the unique system identifier 108 and record identifier(s) 118 so that it will know which information to update. Then, the hub 102 will compare the received data to its data entries and make changes accordingly (e.g., updating the inventory of the oak hammers, Record ID=SS1, to indicate the 15 that the company has in stock). In one embodiment, the hub 102 will only update data based on policies that indicate which external systems 104 or 106 may update data regarding particular attributes or data entries.

Referring still to this non-limiting example, to confirm that the inventory system 106 has the most up to date information, it may be configured to periodically call the hub 102 to retrieve data (e.g., every 15 minutes, etc.). Thus, the inventory system 106 will provide a retrieve call to the hub 102 that comprises its unique system identifier 108 and the data that it wants to update (e.g., “Get Inventory for Record ID=IS1−System ID=IS”). The hub 102, in this example, will parse the call to retrieve the unique system identifier 108 and record identifier(s) 118 so that it will know which attributes the system is requesting and retrieve the data corresponding to that attribute (e.g., “Inventory=15 for IS_Key=IS1”), and return that data to the inventory system 106 so that the inventory system may update its records. Thus, the inventory system 106 may receive data updated within the sales system 104 (and vice versa). With an understanding of the exemplary system overview 100, details regarding an exemplary configuration process may be helpful.

Now referring to FIG. 2, an exemplary configuration process 200 is shown according to one embodiment of the present disclosure. Generally, the exemplary configuration process 200 is the process by which a SAIM central data storage hub is configured to interact with a new external system. As will be understood by one having ordinary skill in the art, the steps and processes shown in FIG. 2 (and those of all other flowcharts and sequence diagrams shown and described herein) may operate concurrently and continuously, are generally asynchronous and independent, and are not necessarily performed in the order shown.

At step 202 in various embodiments, the hub 102 receives an indication to start the exemplary configuration process 200. As will occur to one having ordinary skill in the art, the hub may automatically detect the new external system (e.g., as part of the new system's first call to the hub or when the new system is first connected to the hub) or the hub may receive an affirmative request from a user to configure the new external system. Thus, at step 204 in one embodiment, the hub generates a unique system identifier. In one embodiment, a system administrator manually generates the unique system identifier. Generally, this unique system identifier is an identifier that the hub uses to track and identify the external system (in various embodiments, this unique system identifier may be an IP address of the external system or a particular user of the system, credentials for a particular user of the system, credentials for the system's process, etc.). Consequently, each external system is generally given its own unique system identifier that does not overlap with any of the other unique system identifiers for the other external systems. As will be discussed in association with the description of FIG. 3, the external system, in various embodiments, uses the unique system identifier to identify itself to the hub as part of an exemplary call process. Accordingly, the hub may provide, as part of step 204, the unique system identifier to the external system along with instructions for the external system to include the unique system identifier within any communication with the hub. In various embodiments, the hub tags attributes within its database with the unique system identifiers for the external systems to which the attributes correspond.

Accordingly, at step 206 in various embodiments, the hub retrieves and/or receives a list of the system attributes and record identifiers used by the external system. Generally, the hub may automatically query the external system for the attributes or may receive, through manual input, that list from a user. In various embodiments, at step 208, the hub compares the received system attributes with those already known to/managed by the hub to determine which attributes are new and should be added to the hub. For example, if the new system includes a model name or SKU# attribute that is not known to the hub, then the hub will add a column for that attribute to the data table. Similarly, the hub will compare data within attributes (e.g., size, inventory, etc.) to determine which attributes are already in the hub. Thus, at step 210, in various embodiments, the hub adds the record identifiers and new, unknown attributes to the hub (e.g., by adding a column to the data table, etc.) so that those attributes may be managed by the hub. In various embodiments, at step 212, the hub tags the record identifiers and new, unknown attributes within the hub (that the hub added in step 210) with the unique system identifier (from step 204) so that the hub will be aware of which attributes are used by the external system (e.g., in future calls, etc.). Generally, if a managed attribute is not tagged within the hub, then it may be used by any external system. In contrast, in one embodiment, if an attribute is tagged within the hub, then it may only be used by the external system(s) for which it is tagged. In one embodiment, the hub tags the attributes by including a system identifier within the table itself (e.g., in the columns for the particular attributes). In one embodiment, the hub maintains a separate control table that includes data indicating which attributes correspond to which external systems. Once the hub tags the attributes, then the exemplary configuration process 200 ends thereafter. With an understanding of how the hub is configured to interact with an external system, an explanation of how the hub interacts with that external system may be useful.

Referring now to FIG. 3, an exemplary call process 300 is shown according to one embodiment of the present disclosure. Generally, the exemplary call process 300 is the process by which a SAIM central data storage hub receives a call from an external system. As will occur to one having ordinary skill in the art, this call may be to update data within the hub 102, retrieve data from the hub, or perform some other function.

In various embodiments, the exemplary call process 300 begins at step 302 when the hub receives a call from an external system. This call may be, for example, a call from a sales management system to retrieve data regarding a company's current inventory or a particular product (e.g., comprising a system identifier corresponding to the sales management system and one or more external system attributes, including one or more external system electronic data record identifiers, that indicate the particular product(s) about which to retrieve the identified data from the hub), a call from an inventory management system to update the data regarding a company's current inventory (e.g., comprising a system identifier corresponding to the inventory management system, one or more external system attributes, including one or more external system electronic data record identifiers, that indicate the particular product(s) about which to update the inventory, and the electronic inventory data with which to update the electronic data records of the hub), a call from a lead management system to update the data regarding anticipated demand for a particular product, etc. In one embodiment, this call may be in any format that is acceptable to the hub so long as it contains the unique system identifier corresponding to the external system from which it originates. Generally, the external system modifies its calling process to include the unique system identifier in every call to the hub. In various embodiments, the call may be transmitted through an application program interface, web service call, or other transfer protocol. Thus, at step 304 in various embodiments, the hub parses the call to extract the unique system identifier so that the hub may identify the particular external system that originated the call. Once the hub has extracted the unique system identifier, then the hub will be able to determine the structure of the call (e.g., the syntax of the call, etc.). At step 306, in one embodiment, the hub determines, based on the received call and the extracted unique system identifier, whether the call is to update data within the hub or retrieve data from the hub.

If the call is to retrieve data from the hub, then, in one embodiment, the exemplary call process 300 proceeds at step 308 when the hub compiles a list of requested system attributes from the call. Generally, the hub determines, from the received call and the retrieved unique system identifier, the external system attributes about which the external system has requested data. For example, the external system may have requested data regarding the inventory status, size, or color of all products that a company has in its system. Similarly, at step 308, the hub may also determine the primary record identifiers corresponding to particular data records (from the external system) about which the external system has requested data. For example, the external system may have requested data regarding a particular item (e.g., oak hammer, etc.) that a company has in its system. Thus, at step 310 in one embodiment (e.g., when the call corresponds to attributes regarding all products), the hub determines the managed attributes corresponding to the requested external system attributes (e.g., those data attributes that are within the hub). In one embodiment (e.g., when the call corresponds to all attributes regarding a particular product), the hub determines all of the managed attributes compatible with the external system. Generally, to determine managed attributes that are relevant to an external system, the hub compares the system identifiers (or data from the separate table) of the managed attributes to determine which of those attributes correspond to the external system (e.g., determining that a particular managed attribute from the hub corresponds to a particular attribute in the external system).

At step 311, in various embodiments, the hub determines, from the record identifiers compiled at step 308, the data records about which the external system has requested data. Generally, at step 311, the hub may translate the provided primary record identifiers from the external system into the primary record identifiers of the hub so that the hub may retrieve those data records; similarly, the hub may translate any data from the external system that corresponds to secondary record identifiers compatible with the hub. In one embodiment, filter criteria are applied to the record identifiers and data such that primary record identifiers from the external systems are replaced with the primary record identifiers from the hub and secondary record identifiers are replaced with the appropriate primary record identifiers. For example, filter criteria are applied to a retrieve request from an external system with “System ID=SS” (e.g., Sales System 104 from FIG. 1) and primary record identifier “Record ID=SS1”, such that the primary record identifier is converted to “SS_Key=SS1”, the secondary record identifier from the hub (e.g., from FIG. 1). Continuing with this example, filter criteria are applied to a retrieve request from an external system with “System ID=SS” (e.g., Sales System 104 from FIG. 1) and data “Color=Brown”, such that the data is converted to “Color=C1” (e.g., from FIG. 1). At step 312, in various embodiments, the hub retrieves all of the data corresponding to the system attributes identified at step 310 for the particular data records identified at step 311. In one embodiment, the hub determines, based on one or more policies, whether the external system (and/or a user of the external system) is authorized to retrieve the requested data at step 312. Generally, at step 313, the hub may process the retrieved data so that it is in a format that is compatible with the external system prior to transmitting it to the same (e.g., marking it with the appropriate attributes, truncating entries that are too long, etc.). In one embodiment, the hub may replace the primary record identifiers from the hub within the retrieved data with the primary or secondary record identifiers corresponding to the external system, as appropriate. For example, continuing the previous example, to return color data to an external system, the hub may convert data such as “Color=C1” for “SS_Key=SS1” into “Color=Brown” for “Record ID=SS1” (e.g., from FIG. 1). Thus, at step 314 in one embodiment, the hub transmits the retrieved data to the external system from which the call originated (or an error message if the system/user is not authorized to retrieve the requested data).

If the hub determines, at step 306, that the call is to update data within the hub, then, in one embodiment, the exemplary call process 300 proceeds at step 316 where the hub compiles a list of system attributes and record identifiers from the call for the data records that are to be updated. Generally, the hub determines, from the received call, the external system attributes and data records about which the external system has provided updated data. For example, the external system may have provided updated data regarding the inventory status, size, or color of one or more products that a company has in its system. In one embodiment, the hub may also, at step 316, determine the secondary record identifiers from the hub corresponding to the primary record identifiers from the external system and convert the record identifiers accordingly (e.g., from FIG. 1, primary record identifier “Record ID=IS1” may be converted to secondary record identifier “IS_Key=IS1”). Similarly, at step 316, the hub may also determine the call contains new data records that are to be added to the hub, based on the extracted record identifiers. For example, the external system may have provided data regarding a particular item (e.g., oak hammer, etc.) that a company did not previously have in its system. Thus, at step 318 in one embodiment (e.g., when the call corresponds to updating attributes regarding one or more products), the hub determines the managed attributes corresponding to the provided external system attributes (e.g., those data attributes that are within the hub). In one embodiment (e.g., when the call corresponds to adding new data records), the hub determines all of the managed attributes compatible with the external system. Generally, to determine managed attributes that are relevant to an external system, the hub compares the system identifiers (or data from the separate table) of the managed attributes to determine which of those attributes correspond to the external system (e.g., determining that a particular managed attribute from the hub corresponds to a particular attribute in the external system).

In one embodiment, at step 319, the hub translates the data from the external system so that it is compatible with the hub. For example, the hub may replace any secondary record identifiers with the appropriate primary record identifiers from the hub (e.g., from FIG. 1, data such as “Color=Brown” may be converted to “Color=C1”). At step 320, in various embodiments, the hub updates all of the data corresponding to the system attributes identified at step 318 and data records determined at step 316 within the hub with the data provided in the call. In one embodiment, at step 320, the hub may implement one or more policies to determine whether a particular external system has authority to update a particular attribute (e.g., the sales system could not change a color of a product but could change an inventory status, when inconsistent data is provided the sales system's data takes priority, etc.). Optionally, at step 322, the hub may provide confirmation to the external system regarding the success or failure of the update call. After providing the retrieved data at step 314 or the confirmation at step 322, the exemplary call process 300 ends thereafter.

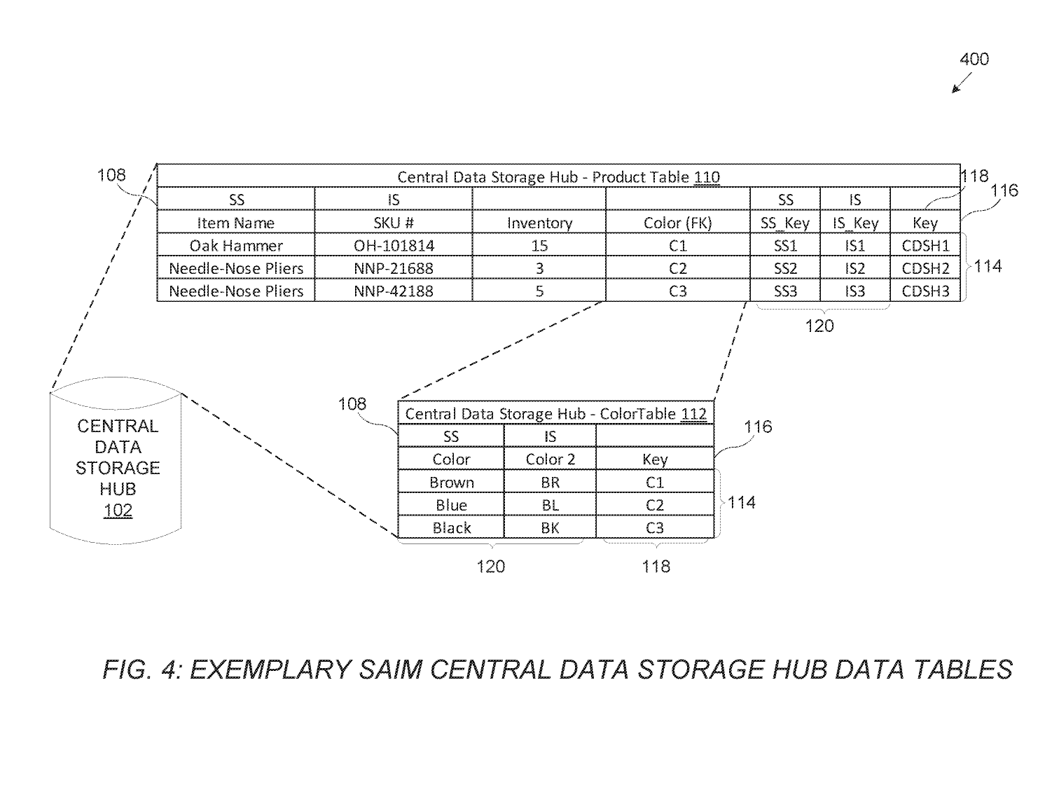

Now referring to FIG. 4, exemplary SAIM central data storage hub data tables 400 are shown according to one embodiment of the present disclosure, with exemplary data entries 114 and attributes 116. Generally, the data tables 110 and 112 are one non-limiting example of how data may be stored in the hub 102. For simplicity's sake, the data tables 110 and 122 are shown as two tables; it should be understood, however, that the hub 102 may comprise an unlimited number of relational data tables or data in other formats. As will occur to one having ordinary skill in the art, the data shown within the data tables 110 and 112 is for exemplary purposes only and may be of any format or complexity.

At its most basic level, the data structure of the hub 102 generally comprises data entries or records 114 (as shown in FIG. 4, rows within the data tables 110 and 112) with data regarding various attributes 116 (as shown in FIG. 4, columns within the data tables 110 and 112). In various embodiments, data entries correspond to a particular item (e.g., physical item, data item, etc.) that the hub 102 is tracking/storing information about, and attributes are the particular details/characteristics of that data particular item. In one embodiment, each data table 110 or 112 may comprise primary record identifiers 118 that are unique to that particular data table 110 or 112 and uniquely identify a particular data record 114 to that data table 110 or 112. Secondary record identifiers 120, in one embodiment, correspond to primary record identifiers 118 or data in other data tables (e.g., the secondary record identifiers 120 within data table 110 correspond to the primary record identifiers 118 from the external systems 104 and 106, the secondary record identifiers 120 within data table 112 correspond to data within the external systems 104 and 106, etc.). In one embodiment, for ease of use, the record identifiers 118 may be hidden within the data table 110 or 112 and not visible to a user.

As shown, in one embodiment each unique attribute is tagged with a system identifier 108 that corresponds to a particular external system (as discussed in association with the description of FIG. 2). In various embodiments, an attribute 116 may be tagged with more than one system identifier 108, no system identifiers 108, or only one system identifier 108 (generally, depending on whether the attribute 116 is used by more than one external system). Similarly, the same attribute 404 may have multiple attribute names (e.g., “Color” and “Size”) depending on whether more than one external system refers to the attribute by different names. By managing the attributes 116 with system identifiers 108, the hub 102 is able to interpret calls from the external systems without requiring the use of complex ETL tools or necessitating the external system understand the data structure of the hub 102.

In one embodiment, if a particular attribute 116 (e.g., color), comprises multiple types of data corresponding to data from two or more external systems, the hub may store the data in a separate data table 112 from its main data table 110. Thus, in one embodiment, the data table 112 may comprise a primary record identifier 118 that is included in the main data table 110 and data records 114 comprising secondary record identifiers 120 that correspond to the data from one or more external systems (e.g., colors “brown”, “blue”, and “black” for one external system with unique system ID “SS” and colors “BR”, “BL”, and “BK” for another external system with unique system ID “IS”). Accordingly, if an external system (e.g., “SS”) requests color data regarding a particular data record (e.g., “Oak Hammer” “SS1”), as discussed in association with the descriptions of FIGS. 1 and 3, then the hub 102 will retrieve the appropriate data from data table 112 (e.g., “Brown”) and provide that data back to the external system.

Generally, the systems and methods described herein improve the functioning of data storage systems. In particular, the system and methods described herein improve the speed and efficiency with which calls are made between central data storage hubs and external systems. Accordingly, the systems and methods described herein improve the data storage system's ability to transfer, update, and retrieve data, amongst other improvements in functionality.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented.

Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A method, comprising the steps of:
receiving, at a centralized data repository, a retrieve call from an external system, wherein the retrieve call comprises a unique system identifier identifying the external system and one or more external system attributes about which to retrieve at least one electronic data record from the centralized data repository;
parsing the retrieve call to extract the unique system identifier;
determining, based on the unique system identifier, one or more centralized data repository attributes corresponding to the one or more external system attributes;
retrieving, from the centralized data repository, one or more electronic data records corresponding to the one or more centralized data repository attributes; and
transmitting, from the centralized data repository, the retrieved one or more electronic data records to the external system.

2. The method of claim 1, wherein the one or more external system attributes comprise one or more external system electronic data record identifiers, wherein the one or more external system electronic data record identifiers specify the at least one electronic data record.

3. The method of claim 2, wherein determining, based on the unique system identifier, one or more centralized data repository attributes corresponding to the one or more external system attributes further comprises determining one or more centralized data repository electronic data record identifiers corresponding to the one or more external system electronic data record identifiers, wherein the one or more centralized data repository electronic data record identifiers specify the one or more electronic data records.

4. The method of claim 3, wherein retrieving, from the centralized data repository, one or more electronic data records corresponding to the one or more centralized data repository attributes further comprises retrieving, from the centralized data repository, one or more electronic data records corresponding to the one or more centralized data repository attributes and the one or more one or more centralized data repository electronic data record identifiers.

5. The method of claim 1, further comprising the step of, prior to transmitting the retrieved one or more electronic data records, formatting the retrieved one or more electronic data records to ensure compatibility with the external system.

6. The method of claim 1, wherein the centralized data repository comprises one or more relational databases.

7. The method of claim 6, wherein the external system comprises one or more relational databases.

8. The method of claim 1, wherein the retrieve call is received at the centralized data repository through one or more application program interfaces.

9. A system, comprising:
an external system that generates a retrieve call and transmits the retrieve call to a centralized data repository, wherein the retrieve call comprises a unique system identifier identifying the external system and one or more external system attributes about which to retrieve at least one electronic data record from the centralized data repository;
the centralized data repository that receives the retrieve call from the external system, wherein the centralized data repository:
parses the retrieve call to extract the unique system identifier,
determines, based on the unique system identifier, one or more centralized data repository attributes corresponding to the one or more external system attributes;
retrieves one or more electronic data records corresponding to the one or more centralized data repository attributes; and
transmits the retrieved one or more electronic data records back to the external system; and
the external system that receives the retrieved one or more electronic data records from the centralized data repository, wherein the external system updates itself based on the retrieved one or more electronic data records.

10. The system of claim 9, wherein the one or more external system attributes comprise one or more external system electronic data record identifiers, wherein the one or more external system electronic data record identifiers specify the at least one electronic data record.

11. The system of claim 10, wherein the centralized data repository, to determine, based on the unique system identifier, one or more centralized data repository attributes corresponding to the one or more external system attributes, further determines one or more centralized data repository electronic data record identifiers corresponding to the one or more external system electronic data record identifiers, wherein the one or more centralized data repository electronic data record identifiers specify the one or more electronic data records.

12. The system of claim 11, wherein the centralized data repository, to retrieve one or more electronic data records corresponding to the one or more centralized data repository attributes, further retrieves, from the centralized data repository, one or more electronic data records corresponding to the one or more centralized data repository attributes and the one or more one or more centralized data repository electronic data record identifiers.

13. The system of claim 9, wherein the central data repository, prior to transmitting the retrieved one or more electronic data records, formats the retrieved one or more electronic data records to ensure compatibility with the external system.

14. The system of claim 9, wherein the centralized data repository comprises one or more relational databases.

15. The system of claim 14, wherein the external system comprises one or more relational databases.

16. The system of claim 9, wherein the external system transmits and the centralized data repository receives the retrieve call through one or more application program interfaces.

17. A method, comprising the steps of:
receiving, at a centralized data repository, an update call from an external system, wherein the update call comprises a unique system identifier, one or more external system attributes about which to update at least one electronic data record, and electronic data to be updated within the at least one electronic data record;
parsing the update call to extract the unique system identifier;
determining, based on the unique system identifier, one or more centralized data repository attributes corresponding to the one or more external system attributes;
identifying one or more electronic data records corresponding to the one or more centralized data repository attributes; and
replacing the identified one or more electronic data records with the electronic data at positions in the one or more electronic data records corresponding to the one or more centralized data repository attributes.

18. The method of claim 17, wherein the step of replacing the identified one or more electronic data records further comprises the steps of:
retrieving one or more update policies;
comparing the electronic data to the one or more update policies; and
replacing, based on the comparison, the identified one or more electronic data records with the electronic data.

19. The method of claim 17, wherein the one or more external system attributes comprise one or more external system electronic data record identifiers, wherein the one or more external system electronic data record identifiers specify the at least one electronic data record.

20. The method of claim 19, wherein determining, based on the unique system identifier, one or more centralized data repository attributes corresponding to the one or more external system attributes further comprises determining one or more centralized data repository electronic data record identifiers corresponding to the one or more external system electronic data record identifiers, wherein the one or more centralized data repository electronic data record identifiers specify the one or more electronic data records.

21. The method of claim 20, wherein identifying one or more electronic data records corresponding to the one or more centralized data repository attributes further comprises identifying one or more electronic data records corresponding to the one or more centralized data repository attributes and the one or more one or more centralized data repository electronic data record identifiers.

22. The method of claim 17, further comprising the step of, prior to replacing the identified one or more electronic data records, formatting the electronic data to ensure compatibility with the centralized data repository.

23. The method of claim 17, wherein the centralized data repository comprises one or more relational databases.

24. The method of claim 23, wherein the external system comprises one or more relational databases.

25. The method of claim 17, wherein the update call is received at the centralized data repository through one or more application program interfaces.

26. A system, comprising:
an external system that generates an update call and transmits the update call to a centralized data repository, wherein the update call comprises a unique system identifier, one or more external system attributes about which to update at least one electronic data record, and electronic data to be updated within the at least one electronic data record; and
the centralized data repository that receives the update call from the external system, wherein the centralized data repository:
parses the update call to extract the unique system identifier;
determines, based on the unique system identifier, one or more centralized data repository attributes corresponding to the one or more external system attributes;
identifies one or more electronic data records corresponding to the one or more centralized data repository attributes; and
replaces the identified one or more electronic data records with the electronic data at positions in the one or more electronic data records corresponding to the one or more centralized data repository attributes.

27. The system of claim 26, wherein the centralized data repository, to replace the identified one or more electronic data records:
retrieves one or more update policies;
compares the electronic data with the one or more update policies; and
replaces, based on the comparison, the identified one or more electronic data records with the electronic data.

28. The system of claim 26, wherein the one or more external system attributes comprise one or more external system electronic data record identifiers, wherein the one or more external system electronic data record identifiers specify the at least one electronic data record.

29. The system of claim 28, wherein the centralized data repository, to determine, based on the unique system identifier, one or more centralized data repository attributes corresponding to the one or more external system attributes, further determines one or more centralized data repository electronic data record identifiers corresponding to the one or more external system electronic data record identifiers, wherein the one or more centralized data repository electronic data record identifiers specify the one or more electronic data records.

30. The system of claim 29, wherein the centralized data repository, to identify one or more electronic data records corresponding to the one or more centralized data repository attributes, further identifies one or more electronic data records corresponding to the one or more centralized data repository attributes and the one or more one or more centralized data repository electronic data record identifiers.

31. The system of claim 26, wherein the centralized data repository, prior to replacing the identified one or more electronic data records, formats the electronic data to ensure compatibility with the centralized data repository.

32. The system of claim 26, wherein the centralized data repository comprises one or more relational databases.

33. The system of claim 31, wherein the external system comprises one or more relational databases.

34. The system of claim 26, wherein the external system transmits and the centralized data repository receives the updates call through one or more application program interfaces.
